(19) United States
(12) Patent Application Publication
(10) Pub. No.: US 2026/0191721 A1
(43) Pub. Date: Jul. 9, 2026

(54) BUCKLE ASSEMBLY AND SLING BARS INCLUDING THE SAME

(71) Applicant: Liko Research & Development AB, Luleå (SE)

(72) Inventors: Yoann Kersuzan, Brandivy (FR); Pascal Lemonnier, Locoal Mendon (FR); Eddy Kerzerho, Ploemel (FR); Pierre Lamy, Lorient (FR); Anthony Thepaut, Lorient (FR); Matthieu Guetta, Pluvigner (FR); Philippe Legros, Pluneret (FR); Mathieu Bernard, Plumergat (FR); Mickael Maho, Pluvigner (FR); Thierry Jaffré, Pluvigner (FR)

(73) Assignee: Liko Research & Development AB, Luleå (SE)

(21) Appl. No.: 19/419,926

(22) Filed: Dec. 15, 2025

Related U.S. Application Data
(60) Provisional application No. 63/743,377, filed on Jan. 9, 2025.
(60) Provisional application No. 63/836,643, filed on Jul. 1, 2025.

(51) Int. Cl. A61G 7/10

(52) U.S. Cl. CPC A61G 7/1069; A61G 7/1051; A61G 7/1073

(57) ABSTRACT

A buckle receiver includes a housing defining a button opening, an inner frame member defining a tongue opening and a tongue cavity, a latch rotatably coupled to the inner frame member, the latch including a protrusion positionable within the tongue cavity, a locking member positionable within the tongue cavity of the inner frame member and biased into a raised position from a lowered position, and a button including a contact portion and an arm extending from the contact portion, the contact portion received within the button opening, the arm abutting against the latch. Movement of the button in a first direction away from the button opening rotates the latch in a first rotation direction. The button is inhibited from moving in the first direction when the locking member is in the raised position. The button is biased in a second direction opposite the first direction toward the button opening.

### CROSS-REFERENCE TO RELATED APPLICATIONS

This application claims the benefit of co-pending U.S. Provisional Patent Application No. 63/743,377, filed Jan. 9, 2025, and U.S. Provisional Patent Application No. 63/836,643, filed Jul. 1, 2025, which are hereby incorporated by reference in their entireties including the drawings.

### TECHNICAL FIELD

The present specification generally relates to sling bars for assisting a person in reaching a standing position and, more specifically, sling bars including assemblies for attaching a lift strap to the sling bar.

### BACKGROUND

In the field of patient lifting and mobility aids, sling bars play a crucial role in supporting slings during use. Traditional mechanisms for attaching lift straps to sling bars typically rely on hooks, clips, or similar securing devices. While these methods have been widely adopted, they present significant challenges in terms of practicality and safety. Notably, hooks and clips often feature crevices or intricate designs that are difficult to access and clean thoroughly. This can lead to hygiene concerns, particularly in medical or care environments where cleanliness is critical to prevent cross-contamination or infection.

Additionally, current attachment mechanisms can pose risks to both caregivers and patients. The design of some mechanisms creates the potential for accidental pinching during the attachment or removal process, which can result in injury. Moreover, many existing solutions lack intuitive features to indicate whether the lift strap is securely attached to the sling bar. This ambiguity increases the risk of operational errors, such as unintentional disconnection of the lift strap during use, compromising patient safety.

Accordingly, a need exists for improved attachment mechanisms that address these issues while maintaining ease of use and reliability.

### SUMMARY

In one embodiment, a buckle receiver includes: a housing defining a button opening; an inner frame member provided within the housing, the inner frame member defining a tongue opening and a tongue cavity; a latch rotatably coupled to the inner frame member, the latch including a protrusion and a button retainer, the protrusion positionable within the tongue cavity; and a button including a contact portion and shaft extending from the contact portion, the contact portion received within the button opening, the shaft received within the button retainer, wherein movement of the button in a first direction away from the button opening rotates the latch in a first rotation direction, wherein the button is biased in a second direction opposite the first direction toward the button opening.

In another embodiment, a buckle assembly includes: a buckle including a tongue and a slot formed in the tongue; and a buckle receiver including: an inner frame member defining a tongue opening; a latch rotatably coupled to the inner frame member, the latch including a protrusion and a button retainer; and a button including a contact portion and shaft extending from the contact portion, the shaft received within the button retainer, wherein the tongue is positionable to extend through the tongue opening and into the inner frame member, wherein the protrusion is positionable into the slot of the tongue when the tongue is received within the inner frame member, wherein movement of the button in a first direction rotates the latch in a first rotation direction, wherein the button is biased in a second direction opposite the first direction.

In yet another embodiment, a sling bar assembly includes: a sling bar including a body and a pair of attachment hooks provided at opposite ends of the body; and a buckle receiver including: a housing defining a button opening; an inner frame member provided within the housing, the inner frame member defining a tongue opening and a tongue cavity, the inner frame member mounted to the body of the sling bar; a latch rotatably coupled to the inner frame member, the latch including a protrusion and a button retainer, the protrusion positionable within the tongue cavity; and a button including a contact portion and shaft extending from the contact portion, the contact portion received within the button opening, the shaft received within the button retainer, wherein movement of the button in a first direction away from the button opening rotates the latch in a first rotation direction, wherein the button is biased in a second direction opposite the first direction toward the button opening.

In yet another embodiment, a person lifting system includes: a lift member movable by a motor; a sling bar configured to be attached to a sling for holding a person; a buckle system for retaining the sling bar to the lift member, wherein the buckle system includes: a buckle provided at an end of the lift member, the buckle including: a tongue; and a slot formed in the tongue; and a buckle receiver mounted on the sling bar, the buckle receiver including: an inner frame member defining a tongue opening; a latch rotatably coupled to the inner frame member, the latch including a protrusion and a button retainer; and a button including a contact portion and shaft extending from the contact portion, the shaft received within the button retainer, wherein the tongue is positionable to extend through the tongue opening and into the inner frame member, wherein the protrusion is positionable into the slot of the tongue when the tongue is received within the inner frame member, wherein movement of the button in a first direction rotates the latch in a first rotation direction, wherein the button is biased in a second direction opposite the first direction.

In yet another embodiment, a buckle receiver includes: a housing defining a button opening; an inner frame member provided within the housing, the inner frame member defining a tongue opening and a tongue cavity; a latch rotatably coupled to the inner frame member, the latch including a pivot bar and a protrusion positionable within the tongue cavity; and a button including a contact portion and an arm extending from the contact portion, the contact portion received within the button opening, the arm rotatably coupled to the pivot bar, wherein movement of the button in a first direction away from the button opening rotates the latch in a first rotation direction, wherein the button is biased in a second direction opposite the first direction toward the button opening.

In yet another embodiment, a buckle receiver includes: a housing defining a button opening; an inner frame member provided within the housing, the inner frame member defining a tongue opening and a tongue cavity; a latch rotatably coupled to the inner frame member, the latch including a protrusion positionable within the tongue cavity; a locking member positionable within the tongue cavity of the inner frame member and biased into a raised position from a lowered position; and a button including a contact portion and an arm extending from the contact portion, the contact portion received within the button opening, the arm abutting against the latch, wherein movement of the button in a first direction away from the button opening rotates the latch in a first rotation direction, wherein the button is inhibited from moving in the first direction when the locking member is in the raised position, wherein the button is biased in a second direction opposite the first direction toward the button opening.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a perspective view of an illustrative lift system including a sling bar coupled to a lift unit, according to one or more embodiments shown and described herein;

FIG. 1B schematically depicts a front perspective view of a lift system including a sling bar including a buckle assembly in an inserted position, according to one or more embodiments shown and described herein;

FIG. 2 schematically depicts a front perspective view of the buckle assembly of FIG. 1B in a removed positioned, according to one or more embodiments shown and described herein;

FIG. 3 schematically depicts a partial rear perspective view of the buckle assembly of FIG. 1B in the inserted position, according to one or more embodiments shown and described herein;

FIG. 4 schematically depicts a front perspective view of an inner frame member of the buckle assembly of FIG. 1B, according to one or more embodiments shown and described herein;

FIG. 5 schematically depicts a rear perspective view of the inner frame member of the buckle assembly of FIG. 1B, according to one or more embodiments shown and described herein;

FIG. 6 schematically depicts a front perspective view of a latch of the buckle assembly of FIG. 1B, according to one or more embodiments shown and described herein;

FIG. 7 schematically depicts a rear perspective view of a button of the buckle assembly of FIG. 1B, according to one or more embodiments shown and described herein;

FIG. 8 schematically depicts a cross-sectional side view of the buckle assembly of FIG. 1B in the inserted position and in a locked state, according to one or more embodiments shown and described herein;

FIG. 9 schematically depicts a cross-sectional side view of the buckle assembly of FIG. 1B in the inserted position and in a compressed state, according to one or more embodiments shown and described herein;

FIG. 10 schematically depicts a cross-sectional side view of the buckle assembly of FIG. 1B in the inserted position and in an unlocked state, according to one or more embodiments shown and described herein;

FIG. 11 schematically depicts a cross-sectional side view of the buckle assembly of FIG. 1B in the removed position and in the unlocked state, according to one or more embodiments shown and described herein;

FIG. 12 schematically depicts a perspective view of another embodiment of a buckle assembly in an inserted position, according to one or more embodiments shown and described herein;

FIG. 13 schematically depicts a cross-sectional side view of the buckle assembly of FIG. 12 in the inserted position and in a locked state, according to one or more embodiments shown and described herein;

FIG. 14 schematically depicts a cross-sectional side view of the buckle assembly of FIG. 12 in the inserted position and in a compressed state, according to one or more embodiments shown and described herein;

FIG. 15 schematically depicts a cross-sectional side view of the buckle assembly of FIG. 12 in the inserted position, according to one or more embodiments shown and described herein;

FIG. 16 schematically depicts a cross-sectional side view of the buckle assembly of FIG. 12 in the removed position and in the unlocked state, according to one or more embodiments shown and described herein;

FIG. 17 schematically depicts a cross-sectional side view of another embodiment of a buckle assembly in an inserted position and in a locked state, according to one or more embodiments shown and described herein;

FIG. 18 schematically depicts a front perspective view of an inner frame member of the buckle assembly of FIG. 17, according to one or more embodiments shown and described herein;

FIG. 19 schematically depicts a rear perspective view of the inner frame member of the buckle assembly of FIG. 17, according to one or more embodiments shown and described herein;

FIG. 20 schematically depicts a front perspective view of a latch of the buckle assembly of FIG. 17, according to one or more embodiments shown and described herein;

FIG. 21 schematically depicts a rear perspective view of a button of the buckle assembly of FIG. 17, according to one or more embodiments shown and described herein;

FIG. 22 schematically depicts a front perspective view of a locking member of the buckle assembly of FIG. 17, according to one or more embodiments shown and described herein;

FIG. 23 schematically depicts a cross-sectional side view of the buckle assembly of FIG. 17 in the inserted position and in the locked state, according to one or more embodiments shown and described herein;

FIG. 24 schematically depicts a cross-sectional side view of the buckle assembly of FIG. 17 in the inserted position and in a compressed state, according to one or more embodiments shown and described herein;

FIG. 25 schematically depicts a cross-sectional side view of the buckle assembly of FIG. 17 in the inserted position and in an unlocked state, according to one or more embodiments shown and described herein; and

FIG. 26 schematically depicts a cross-sectional side view of the buckle assembly of FIG. 17 in a removed position and in the unlocked state, according to one or more embodiments shown and described herein.

### DETAILED DESCRIPTION

Embodiments described herein are directed to buckle receivers for sling bars that engage a buckle coupled to an end of a lift strap to secure the lift strap to the sling bar. The buckle receiver a housing, an inner frame member provided within the housing, a latch rotatably coupled to the inner frame member and positionable within a tongue cavity formed in the inner frame member, and a biased button operable to rotate the latch in and out of the tongue cavity. Various embodiments of the buckle assemblies and the operation of the buckle assemblies are described in more detail herein. Whenever possible, the same reference numerals will be used throughout the drawings to refer to the same or like parts.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

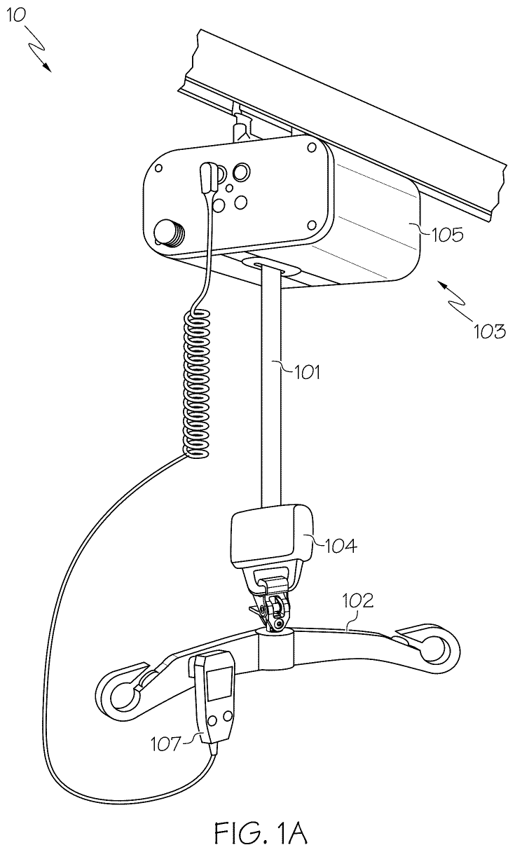

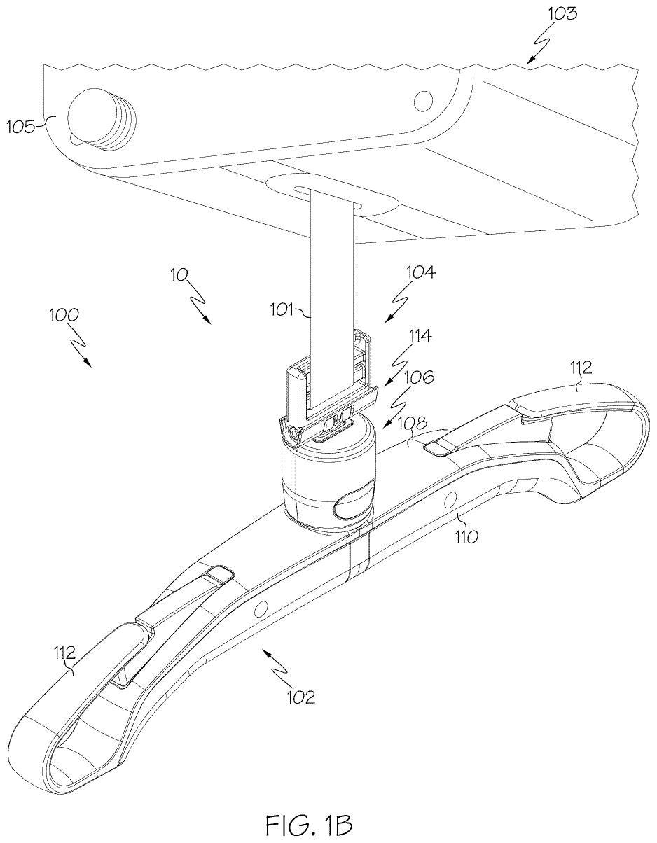

Referring now to FIG. 1A, a perspective view of an illustrative lift system 10 including a sling bar 102 coupled to a lift unit 103 is depicted. In embodiments, the lift unit 103 may be for example, and without limitation, an overhead lift such as a LikoGuard™ Overhead Lift from Liko AB of Lulea, Sweden, or other similar overhead lifts. The lift unit 103 may include a motor (not depicted) enclosed in a housing 105. The motor may be operatively coupled to a lift strap 101. A sling bar attachment mechanism, such as a shackle or buckle 104, may be coupled to a free end the lift strap 101 and the sling bar 102 may be coupled to the sling bar attachment mechanism, thereby coupling the sling bar 102 to the lift strap 101. The motor disposed within housing 105 may wind down (e.g., pay out) the lift strap 101 from the housing 105 to lower the sling bar 102 (e.g., and a subject sling coupled thereto as described herein) and/or wind up (e.g., take up) the lift strap 101 into the housing 105 to raise the sling bar 102 (e.g., and the subject sling coupled thereto as described herein). A lift control device 107 may be communicatively coupled (e.g., wired or wirelessly) to the motor disposed in the housing 105 to control operation of the lift unit 103. The lift unit 103 may be utilized to aid a caregiver in lifting a subject (i.e., a patient) and/or repositioning a subject. Additionally or alternatively, the lift unit 103 may be utilized to support a subject during ambulation.

While FIG. 1 schematically depicts the lift system 10 as an overhead lift, it should be understood that the sling bars 102 described herein may be used in conjunction with other types of lift systems. For example and without limitation, the sling bars described herein may be used in conjunction with mobile lifts, such as the Viking™ series of mobile lifts from Liko AB of Lulea, Sweden, or other similar mobile lifts.

As noted herein, conventional sling bars may include a sling attachment portion that includes a latch or gate that must be actively manipulated to an open position to facilitated inserting a sling loop of a sling or other support device into the sling attachment portion. The process of manipulating the latch and inserting the sling loop may be a two-handed operation such that the caregiver is unable to use one hand to steady the subject in the sling or support device. Further, the operation of the latches or gates of conventional sling bars may create pinch points in which the sling loop may become entangled or ensnared, requiring that the sling loop be adjusted or reset in the sling attachment portion of the sling bar. Adjusting or resetting the sling loop may further complicate and/or protract the process of attaching the sling loop to the sling attachment portion of the sling bar.

The embodiments of the sling bars described herein mitigate these issues with conventional sling bars by utilizing a strap guide slot to guide the sling loop into the sling attachment portion of the sling bar in combination with a retention spring to passively retain the sling loop in the sling attachment portion of the sling bar.

Referring now to FIG. 1B, the lift system 10 is illustrated according to one or more embodiments described herein. In embodiments, the lift system 10 includes a lift member such as a lift beam and/or the lift strap 101 extending from a sling bar assembly 100. In some embodiments, the lift strap 101 may extend between a lift arm, lift beam, or the lift unit 103 and the sling bar assembly 100. The sling bar assembly 100 may generally include the sling bar 102 and the buckle 104 is provided at an end of the lift strap 101 opposite the lift beam or the lift unit 103. As shown, the buckle 104 engages a buckle receiver 106 mounted to an upper surface 108 of a body 110 of the sling bar 102.

In embodiments, the lift unit 103 is operated, via a controller and a motor, to retract a portion of the lift strap 101 into the lift unit 103 or, alternatively, allow a portion of the lift strap 101 to extend out of the lift unit 103, thereby lifting or lowering the sling bar 102 relative to the lift unit 103. This assists in aiding a person wearing a sling attached at attachment hooks 112 provided at opposite ends of the body 110 of the sling bar 102 to be raised into a standing position or lowered into a seated or laying down position.

Referring still to FIG. 1B, the buckle receiver 106 is provided on the upper surface 108 of the body 110 of the sling bar 102 substantially at a central location between the attachment hooks 112. However, it should be appreciated that the buckle receiver 106 may be positioned at any suitable location on the body 110 of the sling bar 102. For example, the buckle receiver 106 may be positioned on a rear surface or a front surface of the body 110 of the sling bar 102. Additionally, in some embodiments, the buckle receiver 106 may be located closer to one of the attachment hooks 112. Throughout the ensuing description, the combination of the buckle 104 and the buckle receiver 106 may be referred to herein as a buckle assembly 114. As shown in FIG. 1B, the buckle 104 is shown inserted into the buckle receiver 106. Accordingly, the buckle assembly 114 is depicted in an inserted position.

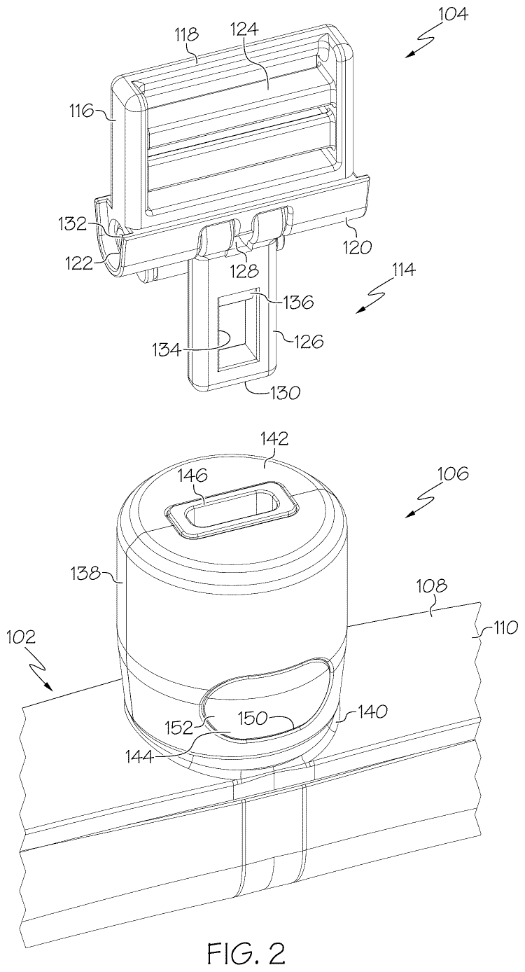

Referring now to FIG. 2, the buckle 104 is shown removed from the buckle receiver 106. Accordingly, the buckle assembly 114 is depicted in a removed position. As shown in FIG. 2, the buckle 104 includes a strap receiving portion 116 that engages an end of the lift strap 101 opposite the lift unit 103 (FIG. 1A). The strap receiving portion 116 includes an upper end 118 and a lower end 120 opposite the upper end 118. In embodiments, a channel 122 may be formed through the lower end 120.

It should be appreciated that the end of the lift strap 101 (FIG. 1A) engages and is secured to the strap receiving portion 116 in any suitable manner. For example, the end of the lift strap 101 may be looped through one or more openings 124 formed in the strap receiving portion 116 and further secured to the buckle 104 or back onto a portion of the lift strap 101 itself. In other embodiments, the lift strap 101 may include one or more securement features provided at the end of the list strap 101 to mechanically engage the strap receiving portion 116.

The buckle 104 further includes a tongue 126 extending from the strap receiving portion 116. The tongue 126 includes an upper end 128 and a lower end 130 opposite the upper end 128. In embodiments, the tongue 126 is rotatable coupled to the strap receiving portion 116. In other embodiments, the tongue 126 is fixed to the strap receiving portion 116 to inhibit any movement of the tongue 126 relative to the strap receiving portion 116. In embodiments in which the tongue 126 is rotatable coupled to the strap receiving portion 116, the tongue 126 may include a post 132 extending laterally from the upper end 128. The post 132 may extend through the channel 122 formed through the lower end 120 of the strap receiving portion 116 to secure the tongue 126 to the strap receiving portion 116 and permit rotation of the tongue 126 relative to the strap receiving portion 116. In other embodiments, the post 132 may extend through the channel 122 formed in the strap receiving portion 116 and a channel formed in the tongue 126. Additionally, a slot 134 is formed in the tongue 126 proximate the lower end 130 of the tongue 126 and a tapered edge 136 extends into the slot 134 from an end of the slot 134 opposite the lower end 130 of the tongue 126.

Referring still to FIG. 2, the buckle receiver 106 is shown including a housing 138 mounted to the upper surface 108 of the body 110 of the sling bar 102. However, as described herein, the buckle receiver 106 may be mounted to any suitable portion of the sling bar 102. The housing 138 of the buckle receiver 106 generally includes a lower surface 140, an upper surface 142 opposite the lower surface 140, and a side wall 144 extending between the lower surface 140 and the upper surface 142. A frame opening 146 is formed in the upper surface 142 of the housing 138 of the buckle receiver 106. In embodiments, as shown in FIG. 2, a button opening 150 is formed in the side wall 144 and a button 152 is received within the button opening 150.

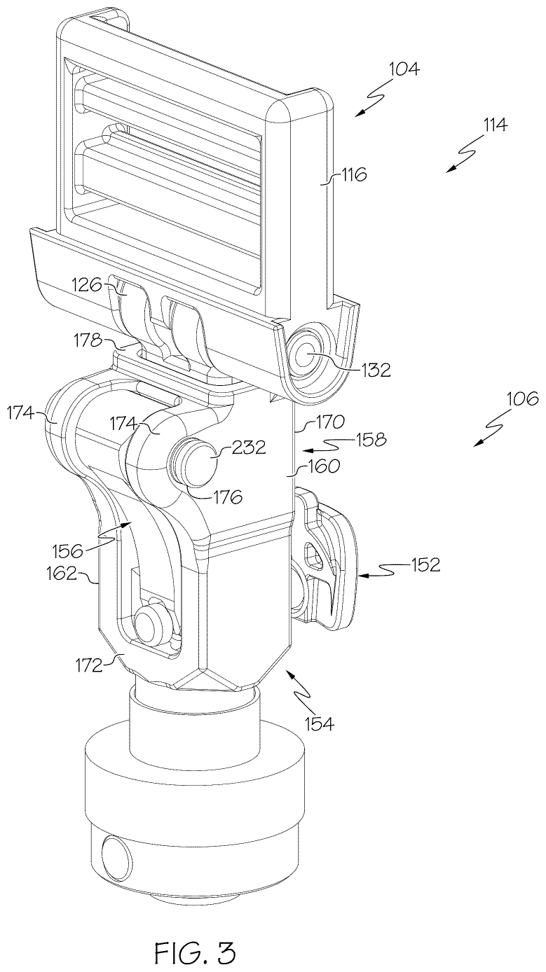

Referring now to FIG. 3, a rear perspective view of the buckle assembly 114 is shown in the inserted position with the housing 138 of the buckle receiver 106 removed to better illustrate the internal components of the buckle receiver 106. Specifically, the buckle receiver 106 further includes an inner frame member 154, a latch 156 rotatably coupled to the inner frame member 154, and the button 152 extending through the inner frame member 154 and the latch 156.

With the tongue 126 fully inserted into the inner frame member 154 of the buckle receiver 106, as described in more detail herein, the buckle assembly 114 is referred to herein as being in the inserted position. Alternatively, with the tongue 126 not fully inserted into the inner frame member 154 of the buckle receiver 106, as shown in FIG. 2, the buckle assembly 114 is in a removed position.

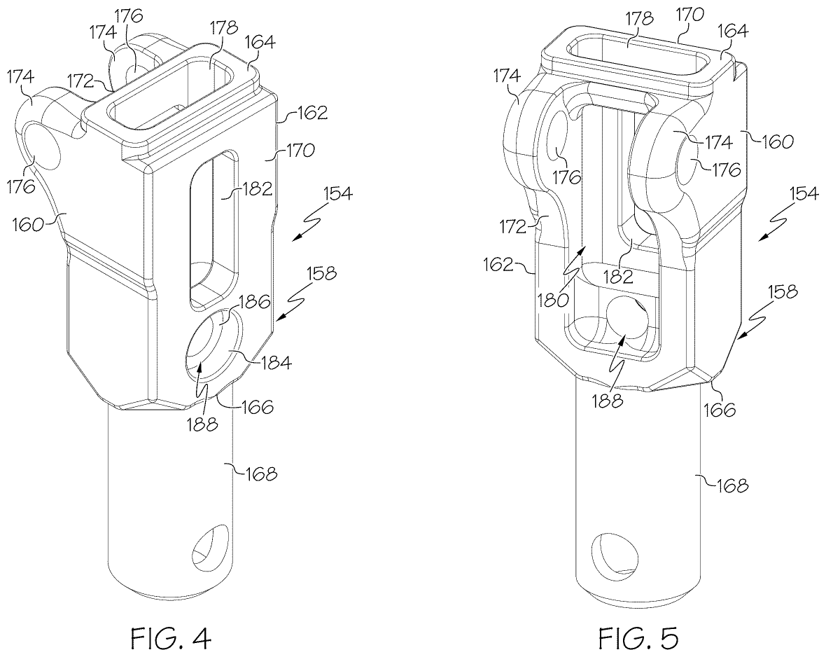

Referring now to FIGS. 4 and 5, the inner frame member 154 is shown apart from the other components of the buckle receiver 106. The inner frame member 154 includes a body 158 having a first side wall 160, a second side wall 162 opposite the first side wall 160, an upper surface 164 extending between the first side wall 160 and the second side wall 162, a lower surface 166 opposite the upper surface 164, a sling engagement portion 168 extending from the lower surface 166, a front surface 170, and a rear surface 172 opposite the front surface 170. In embodiments, the first side wall 160 and the second side wall 162 each include a lobe 174 extending in a direction opposite the front surface 170 and an aperture 176 is formed in each of the lobes 174. The sling engagement portion 168 facilitates attachment of the inner frame member 154 to the body 110 of the sling bar 102 (FIG. 1B).

A tongue opening 178 is formed in the upper surface 164 of the body 158 of the inner frame member 154 to permit the tongue 126 of the buckle 104 (FIG. 3) to extend into a tongue cavity 180 defined between the first side wall 160 and the second side wall 162 as the buckle 104 is brought into engagement with the buckle receiver 106. Accordingly, the tongue opening 178 has a shape corresponding to a shape of the tongue 126.

In embodiments, a latch slot 182 is formed in the front surface 170 of the body 158 of the inner frame member 154. The latch slot 182 extends in a vertical direction between the lower surface 166 and the tongue opening 178 at the upper surface 164 and the lower surface 166. A button recess 184 is formed in the front surface 170 of the body 158 of the inner frame member 154 proximate the lower surface 166. A recess wall 186 is recessed from the front surface 170 of the body 158 of the inner frame member 154 and partially defines the button recess 184. In embodiments in which the latch slot 182 is provided, the button recess 184 is formed between the latch slot 182 and the lower surface 166 of the body 158 of the inner frame member 154. An inner button channel 188 extends from the recess wall 186 into the tongue cavity 180. The inner button channel 188 has an inner diameter less than an inner diameter of the button recess 184.

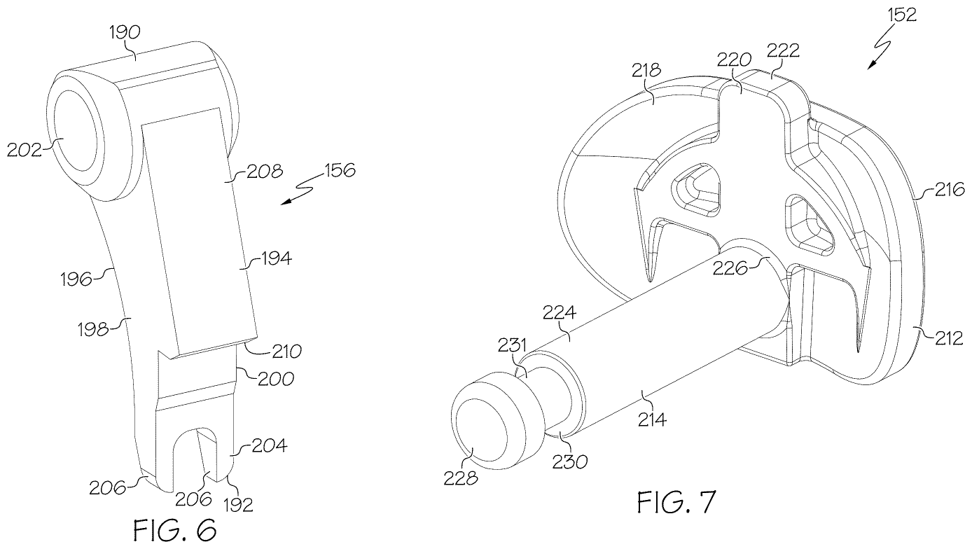

Referring now to FIG. 6, the latch 156 is shown apart from the other components of the buckle receiver 106. The latch 156 includes an upper end 190, a lower end 192 opposite the upper end 190, a front surface 194, a rear surface 196 opposite the front surface 194, a first side wall 198 extending between the front surface 194 and the rear surface 196, and a second side wall 200 opposite the first side wall 198 and extending between the front surface 194 and the rear surface 196.

In embodiments, a bore 202 is formed at the upper end 190 of the latch 156 extending through the first side wall 198 and the second side wall 200. In embodiments, a button retainer 204 is formed in the lower end 192 of the latch 156. The button retainer 204 defines a pair of fingers 206 spaced apart from one another and extending in a direction opposite the upper end 190. In embodiments, the front surface 194 of the latch 156 includes a protrusion 208 extending in a direction away from the rear surface 196 of the latch 156. The protrusion 208 defines a lower wall 210. In embodiments, the lower wall 210 is planar. In other embodiments, a tooth or other friction inducing feature may be provided on the lower wall 210 and extending in a direction toward the lower end 192 of the latch 156.

Referring now to FIG. 7, the button 152 is shown apart from the other components of the buckle receiver 106. The button 152 includes a contact portion 212 and a shaft 214 extending from the contact portion 212. The contact portion 212 includes a front surface 216 and a rear surface 218 opposite the front surface 216. In embodiments, the front surface 216 has a convex shape. In embodiments, the rear surface 218 has a concave shape such that the contact portion 212 as a whole has a curved shape. In embodiments, a tab 220 is provided on the rear surface 218 of the contact portion 212 and an upper end 222 of the tab 220 extends past the contact portion 212 such as, for example, above the contact portion 212. In other embodiments, the tab 220 extends below or to one or both sides of the contact portion 212. In embodiments, a visual indicator is provided along a perimeter of the contact portion 212. For example, the visual indicator may be a color different than a color of the contact portion 212 itself, which is only visible through the button opening 150 when the button 152 is in an extended position.

The shaft 214 of the button 152 includes a body 224 having a front end 226 and a rear end 228 opposite the front end 226. The front end 226 of the body 224 of the shaft 214 is fixed to the rear surface 218 of the contact portion 212. In embodiments, the shaft 214 may be formed as a one-piece, monolithic structure with the contact portion 212. In other embodiments, the shaft 214 may be separately formed and attached to the contact portion 212. A notch 230 is formed in the body 224 of the shaft 214 between the front end 226 and the rear end 228. Accordingly, the notch 230 defines a reduced diameter portion 231 having a diameter less than a diameter of the rest of the body 224.

Referring again to FIG. 3, the latch 156 is shown provided between the first side wall 160 and the second side wall 162 of the inner frame member 154. A pin 232 extends through the lobes 174 formed in the first side wall 160 and the second side wall 162, and the latch 156 to rotatably couple the latch 156 to the inner frame member 154. As described in more detail herein, the latch 156 rotates relative to the inner frame member 154 about the pin 232 to engage the tongue 126 when the latch 156 is received within the tongue cavity 180 of the inner frame member 154. Engagement of the latch 156 with the tongue 126 inhibits removal of the buckle 104 from the buckle receiver 106.

Referring now to FIG. 8, a cross-sectional side view of the buckle assembly 114 is shown in the inserted position and in a locked state. As shown, the housing 138 of the buckle receiver 106 is provided around the inner frame member 154 to enclose the other components of the buckle receiver 106, thereby protecting the components from damage and unintended external contact. With the housing 138 positioned around the inner frame member 154, the upper surface 164 of the inner frame member 154 is received within the frame opening 146 of the housing 138.

Additionally, as shown in FIG. 8, the housing 138 includes a guide wall 234 extending from the button opening 150. The guide wall 234 defines an outer button channel 236 to assist with guiding the contact portion 212 of the button 152 along the outer button channel 236 during depression of the button 152. In embodiments, the guide wall 234 includes a cutout 238 for receiving the tab 220 of the button 152 when the contact portion 212 is positioned within the button opening 150 formed in the housing 138. As shown, a biasing member 240 such as, for example, a spring, circumscribes the body 224 of the shaft 214 of the button 152 and is positioned between the rear surface 218 of the contact portion 212 of the button 152 and the recess wall 186 of the inner frame member 154. Accordingly, upon the button 152 being depressed, the button 152 is biased by the biasing member 240 back toward an extended position as shown in FIG. 8. As noted above, a visual indicator may be provided along the perimeter of the contact portion 212. Accordingly, with the button 152 in the extended position shown in FIG. 8, the visual indicator may be visible from outside of the housing 138.

Additionally, the shaft 214 of the button 152 extends through the button recess 184 and the inner button channel 188 formed in the inner frame member 154 and engages the latch 156. Specifically, shaft 214 of the button 152 extends between the pair of fingers 206 defining the button retainer 204 of the latch 156 such that the fingers 206 are received within the notch 230 formed in the shaft 214 of the button 152. The diameter of the reduced diameter portion 231 is less than a distance between the fingers 206 of the button retainer 204. Additionally, the outer diameter of the shaft 214 of the button 152 forward and rearward of the notch 230 is greater than the distance between the fingers 206 of the button retainer 204. Accordingly, any movement of the button 152 by pressing the contact portion 212 into the housing 138 or permitting the button 152 to return to its initial position within the button opening 150 of the housing 138 results in a corresponding rotating movement of the latch 156 about the pin 232.

During insertion of the tongue 126 into the tongue cavity 180 of the inner frame member 154, the lower end 130 of the tongue 126 contacts the protrusion 208 formed on the front surface 194 of the latch 156 to rotate the latch 156 in a first rotation direction, such as a clockwise direction, about the pin 232. Clockwise rotation of the latch 156 draws the button 152 further into the housing 138 due to the engagement of the latch 156 and the shaft 214 of the button 152. Once the lower end 130 of the tongue 126 is lower than the lower wall 210 of the protrusion 208, the biasing member 240 urges the button 152 back into the button opening 150 formed in the housing 138 and rotates the latch 156 back in a second rotation direction opposite the first rotation direction, such as a counterclockwise direction, such that the protrusion 208 enters the slot 134 formed in the tongue 126. Moreover, the lower wall 210 of the protrusion 208 abuts against the lower end 130 of the tongue 126 to form a friction fit and inhibit incidental rotation of the latch 156.

It should be appreciated that reference to clockwise or clockwise rotation of the latch 156 is merely with respect to the view shown in FIGS. 8-11. Accordingly, the direction of rotation would be opposite if viewed from the opposite side of the buckle assembly 114.

With the protrusion 208 received within the slot 134 formed in the tongue 126 and the lower wall 210 of the protrusion 208 abutting against the lower end 130 of the tongue 126, the buckle assembly 114, while still in the inserted position, is in the locked state.

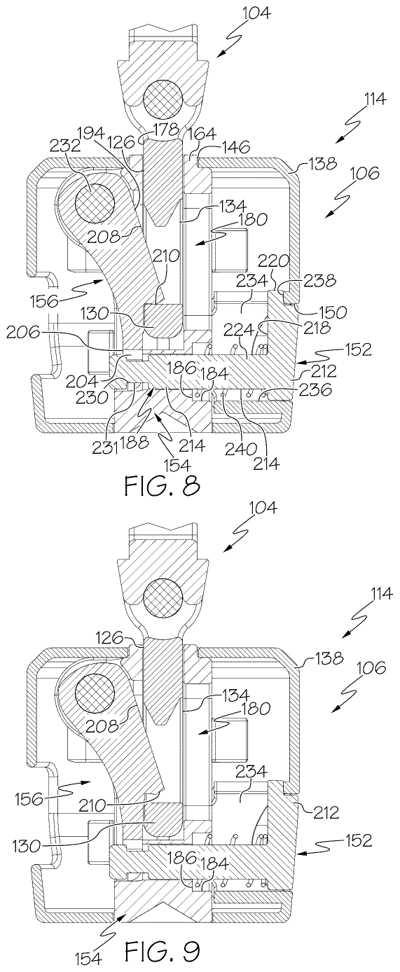

Referring now to FIG. 9, steps are taken to remove the buckle 104 from the buckle receiver 106 by initially lifting the buckle receiver 106 relative to the buckle 104. This may be done by lifting the sling bar 102 (FIG. 1B) to which the buckle receiver 106 is attached. By lifting the buckle receiver 106, the lower wall 210 of the protrusion 208 no longer abuts against the lower end 130 of tongue 126. With the buckle receiver 106 lifted relative to the buckle 104, the buckle assembly 114, while still in the inserted position, is in a compressed state. Alternatively, the buckle 104 may be lowered or pushed toward the buckle receiver 106 to position the buckle assembly 114 into the compressed state.

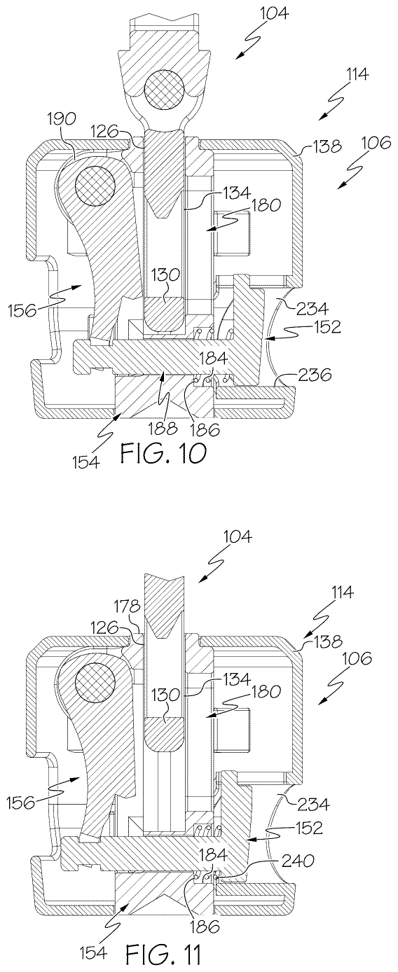

Thereafter, as shown in FIG. 10, the button 152 may be depressed to translate in a first direction along the outer button channel 236 and the inner button channel 188 and rotate the latch 156 in the clockwise direction. With the latch 156 rotated in the clockwise direction, the protrusion 208 is removed from the slot 134 formed in the tongue 126 and the tongue cavity 180 formed in the inner frame member 154, thereby permitting the buckle 104 to be removed from the buckle receiver 106. With the latch 156 disengaged from the tongue 126, the buckle assembly 114, while still in the inserted position, is in an unlocked state. With the button 152 in the retracted or depressed position shown in FIG. 10, the visual indicator may not be visible from outside of the housing 138.

Referring now to FIG. 11, with the buckle assembly 114 in the unlocked state, the tongue 126 is permitted to be removed from the tongue cavity 180 formed in the inner frame member 154. This may be done by lowering the buckle receiver 106 relative to the buckle 104 or alternatively lifting the buckle 104 relative to the buckle receiver 106. In either instance, the tongue 126 slides out of the tongue opening 178 formed in the inner frame member 154. Once the tongue 126 is removed from the inner frame member 154, the biasing member 240 urges the button 152 in a second direction opposite the first direction back to the extended position, thereby rotating the latch 156 back in the counterclockwise direction.

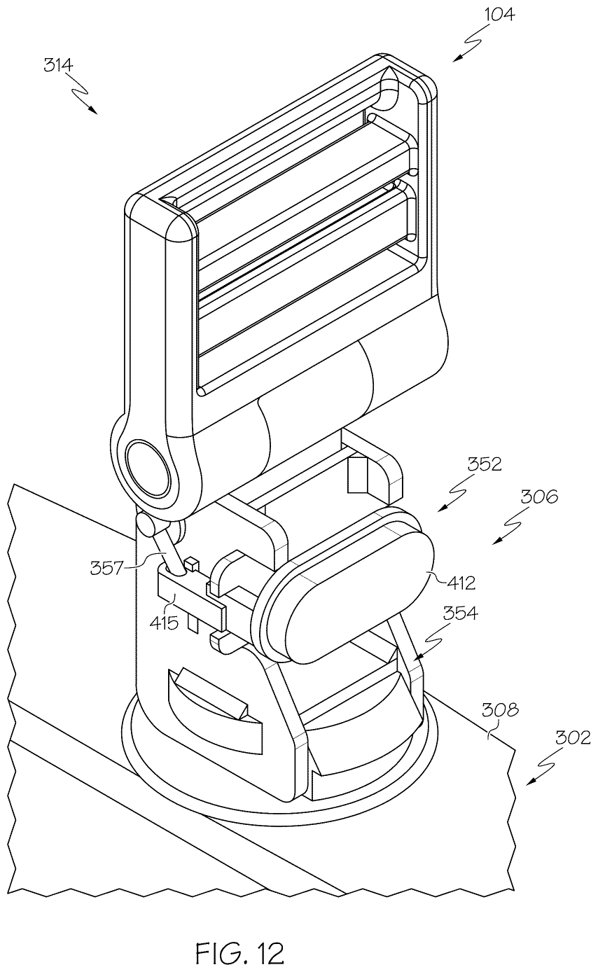

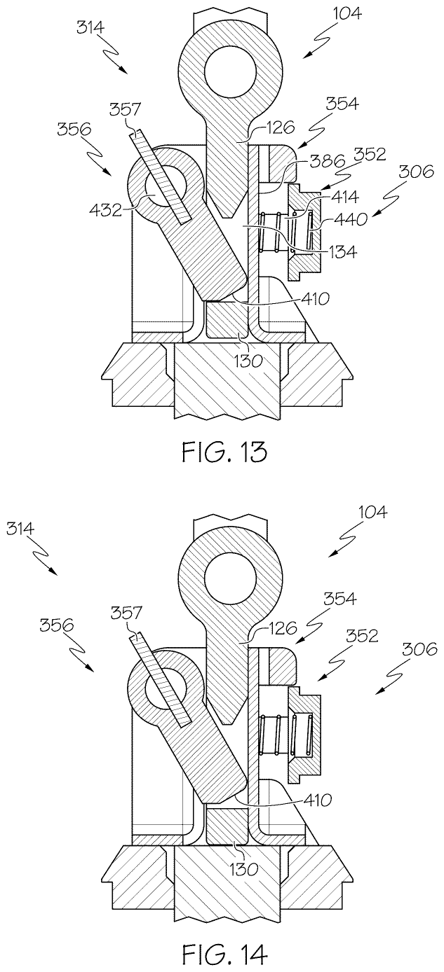

Referring now to FIG. 12, another embodiment of a buckle assembly 314 mounted to an upper surface 308 of a sling bar 302 is depicted. It should be appreciated that the buckle assembly 314 is similar to the buckle assembly 114 described herein and illustrated in FIG. 1. Specifically, the buckle assembly 314 includes the buckle 104 and a buckle receiver 306 in which the buckle 104 is received. The buckle receiver 306 includes a housing (not shown), an inner frame member 354 provided within the housing, a latch 356 (FIG. 13), and a button 352 rotatably coupled to the latch 356. One difference between the buckle assembly 314 of FIG. 12 and the buckle assembly 114 of FIG. 1B is that the button 352 does not engage the latch 356 by extending through the inner frame member 354. Rather, the button 352 extends along an outside surface of the inner frame member 354 and is rotatably coupled to a pivot bar 357, which is coupled to the latch 356.

As shown in FIG. 12, the button 352 includes a contact portion 412 and one or more arms 415 extending from the contact portion 412. In embodiments, the button 352 includes a pair of arms 415 extending from opposite sides of the contact portion 412. The pivot bar 357 is rotatably coupled to at least one of the arms 415 and fixed to the latch 356 (FIG. 13). In embodiments in which the button 352 includes the pair of arms 415, a pivot bar 357 is rotatably coupled to each arm 415 of the button 352. Accordingly, as described in more detail herein, as force is applied against the contact portion 412 of the button 352 to move the button 352 further into the housing and/or the inner frame member 354, the pivot bar 357 rotates relative to the one or more arms 415 of the button 352 and causes a corresponding rotation of the latch 356, thereby positioning the buckle assembly 314 into an unlocked state from a locked state and permitting the buckle 104 to be removed from the buckle receiver 306.

Referring now to FIG. 13, a cross-sectional side view of the buckle assembly 314 is shown in the inserted position and in the locked state. As shown in FIG. 13, a biasing member 440 such as, for example, a spring, circumscribes a shaft 414 of the button 352, which extends at least partially through the inner frame member 354 and is positioned between a rear surface of the contact portion 412 of the button 352 and a recess wall 386 of the inner frame member 354. Accordingly, upon the button 352 being depressed, the button 352 is biased by the biasing member 440 back toward an extended position as shown in FIG. 11.

The latch 356 is rotatably fixed to the inner frame member 354 via a pin 432. Additionally, although not shown in FIG. 13, as described herein and illustrated in FIG. 12, the one or more arms 415 of the button 352 are rotatably coupled to the pivot bar 357, which is fixed to the latch 356. Accordingly, any movement of the button 352 by pressing the contact portion 412 toward the latch 356 or permitting the button 352 to return to its initial position results in a corresponding rotating movement of the latch 356 about the pin 432.

During insertion of the tongue 126 of the buckle 104 into the inner frame member 354, the lower end 130 of the tongue 126 contacts the latch 356 to rotate the latch 356 in a first rotation direction, such as a clockwise direction, about the pin 432. Clockwise rotation of the latch 356 draws the button 352 further into the inner frame member 354 due to the engagement of the latch 356 and the one or more arms 415 (FIG. 12) of the button 352 via the pivot bar 357. Once the lower end 130 of the tongue 126 is lower than a lower wall 410 of the latch 356, the biasing member 440 urges the button 352 back into the original position and rotates the latch 356 back in a second rotation direction opposite the first rotation direction, such as a counterclockwise direction, such that the lower wall 410 of the latch 356 is removed from the slot 134 formed in the tongue 126. Moreover, the lower wall 410 of the latch 356 abuts against the lower end 130 of the tongue 126 to form a friction fit and inhibit incidental rotation of the latch 356.

It should be appreciated that reference to clockwise or clockwise rotation of the latch is merely with respect to the view shown in FIGS. 13-16. Accordingly, the direction of rotation would be opposite if viewed from the opposite side of the buckle assembly 314.

With the latch 356 received within the slot 134 formed in the tongue 126 and the lower wall 410 of the latch 356 abutting against the lower end 130 of the tongue 126, the buckle assembly 314, while still in the inserted position, is in the locked state.

Referring now to FIG. 14, steps are taken to remove the buckle 104 from the buckle receiver 306 by initially lifting the buckle receiver 306 relative to the buckle 104. This may be done by lifting a lift bar to which the buckle receiver 306 is attached. By lifting the buckle receiver 306, the lower wall 410 of the latch 356 no longer abuts against the lower end 130 of tongue 126. With the buckle receiver 306 lifted relative to the buckle 104, the buckle assembly 314, while still in the inserted position, is in a compressed state. Alternatively, the buckle 104 may be lowered or pushed toward the buckle receiver 306 to position the buckle assembly 314 into the compressed state.

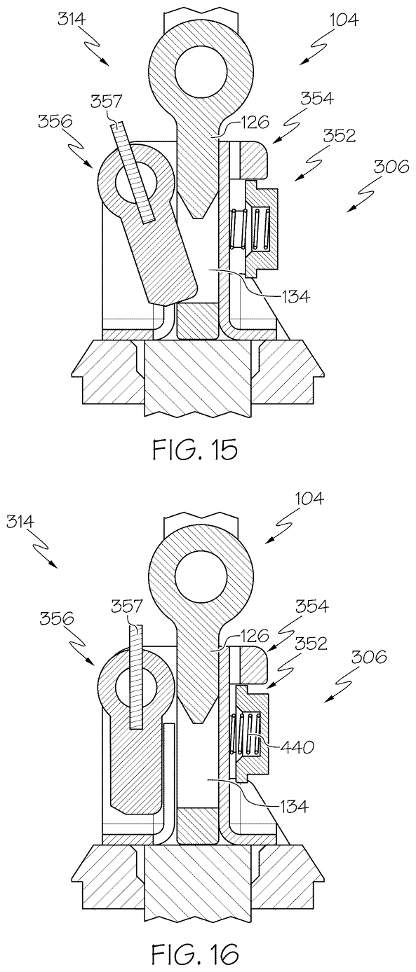

Thereafter, as shown in FIG. 15, the button 352 may be depressed to translate in a first direction toward the latch 356 and rotate the latch 356 in the clockwise direction. Referring now to FIG. 16, the button 352 is further depressed to translate in the first direction toward the latch 356 and further rotate the latch 356 in the clockwise direction. With the latch 356 rotated in the clockwise direction, the latch 356 is removed from the slot 134 formed in the tongue 126, thereby permitting the buckle 104 to be removed from the buckle receiver 306. With the latch 356 disengaged from the tongue 126, the buckle assembly 314, while still in the inserted position, is in an unlocked state.

With the buckle assembly 314 in the unlocked state, the tongue 126 is permitted to be removed from the inner frame member 354. This may be done by lowering the buckle receiver 306 relative to the buckle 104 or alternatively lifting the buckle 104 relative to the buckle receiver 306. In either instance, the tongue 126 slides out of the inner frame member 354. Once the tongue 126 is removed from the inner frame member 354, the biasing member 440 urges the button 352 in a second direction opposite the first direction back to the extended position, thereby rotating the latch 356 back in the counterclockwise direction.

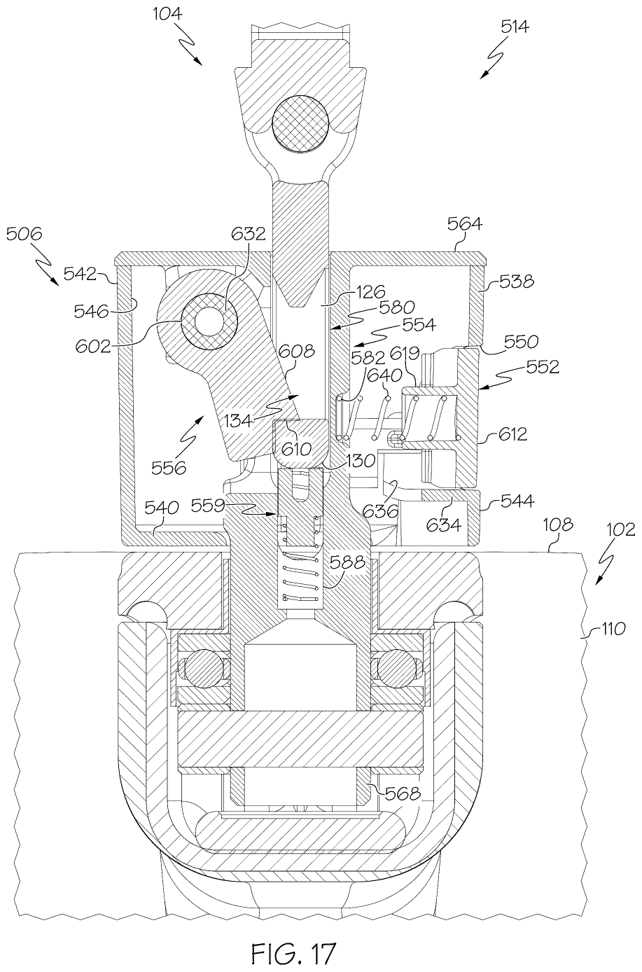

Referring now to FIG. 17, the buckle 104 is shown engaging another embodiment of a buckle receiver 506 mounted to the upper surface 108 of the body 110 of the sling bar 102. Throughout the ensuing description, the combination of the buckle 104 and the buckle receiver 506 may be referred to herein as a buckle assembly 514. As shown in FIG. 17, the buckle 104 is shown inserted into the buckle receiver 506. Accordingly, the buckle assembly 514 is depicted in an inserted position. Alternatively, with the buckle 104 removed from the buckle receiver 506, the buckle assembly 514 is referred to as being in a removed position, as shown in FIG. 26.

Referring still to FIG. 17, a cross-sectional side view of the buckle assembly 514, taken through a lateral center of the buckle assembly 514, is depicted. The buckle receiver 506 is shown including a housing 538 mounted to the upper surface 108 of the body 110 of the sling bar 102. However, as described herein, the buckle receiver 506 may be mounted to any suitable portion of the sling bar 102. The housing 538 of the buckle receiver 506 generally includes a lower surface 540, an upper surface 542 opposite the lower surface 540, and a side wall 544 extending between the lower surface 540 and the upper surface 542. A frame opening 546 is formed in the upper surface 542 of the housing 538 of the buckle receiver 506. In embodiments, a button opening 550 is formed in the side wall 544 of the housing 538 and a button 552 is received within the button opening 550.

The buckle receiver 506 further includes an inner frame member 554, a latch 556 rotatably coupled to the inner frame member 554, and the button 552 extending through the inner frame member 554. It should be appreciated that the buckle assembly 514 is similar to the buckle assemblies 114, 314 of FIGS. 2 and 12, respectively. One difference between the buckle assembly 514 of FIG. 17 and the buckle assemblies 114, 314 of FIGS. 2 and 12 is that the buckle assembly 514 includes a locking member 559 inhibiting movement of the button 552 until the buckle receiver 506 is raised relative to the buckle 104. Accordingly, the locking member 559 also inhibits incidental rotation of the latch 556 prior to the buckle receiver 506 being raised relative to the buckle 104, as described in more detail herein. As shown in FIG. 17, the buckle 104 is shown inserted into the buckle receiver 506. Accordingly, the buckle assembly 514 is depicted in an inserted position.

Referring still to FIG. 17, a side view of the buckle assembly 514 is shown in the inserted position. With the tongue 126 fully inserted into the inner frame member 554 of the buckle receiver 506, the buckle assembly 514 is referred to herein as being in the inserted position. Alternatively, with the tongue 126 not fully inserted into the inner frame member 554 of the buckle receiver 506, as shown in FIG. 26, the buckle assembly 514 is in a removed position.

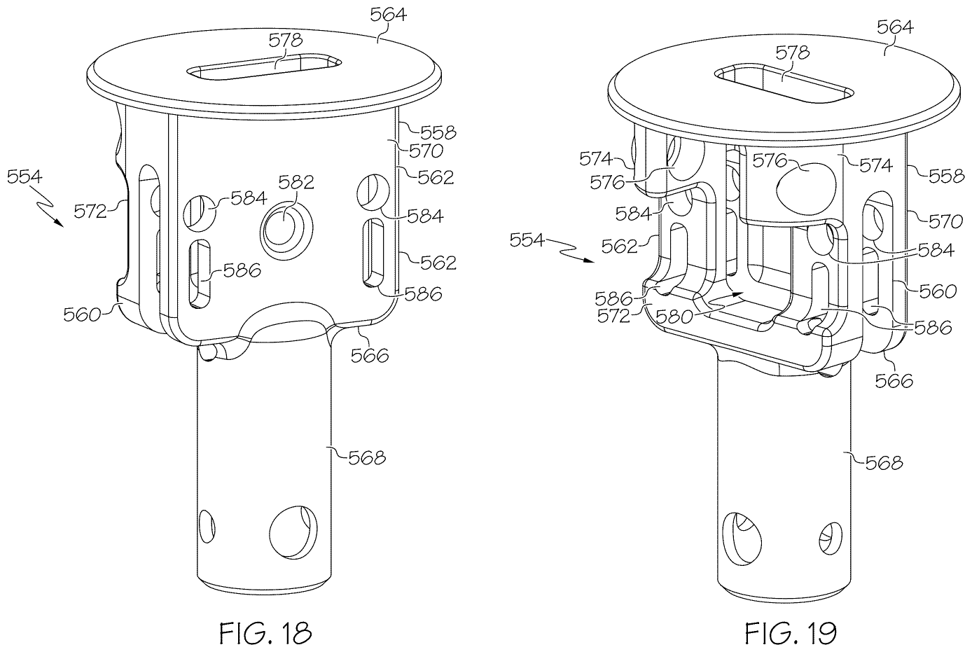

Referring now to FIGS. 18 and 19, the inner frame member 554 is shown apart from the other components of the buckle receiver 506. The inner frame member 554 includes a body 558 having a first side wall 560, a second side wall 562 opposite the first side wall 560, an upper surface 564 extending between the first side wall 560 and the second side wall 562, a lower surface 566 opposite the upper surface 564, a sling engagement portion 568 extending from the lower surface 566, a front surface 570, and a rear surface 572 opposite the front surface 570. In embodiments, the first side wall 560 and the second side wall 562 each include a lobe 574 extending in a direction opposite the front surface 570 and an aperture 576 is formed in each of the lobes 574. The sling engagement portion 568 facilitates attachment of the inner frame member 554 to the body 110 of the sling bar 102 (FIG. 17).

A tongue opening 578 is formed in the upper surface 564 of the body 558 of the inner frame member 554 to permit the tongue 126 of the buckle 104 (FIG. 17) to extend into a tongue cavity 580 defined between the first side wall 560 and the second side wall 562 as the buckle 104 is brought into engagement with the buckle receiver 506. Accordingly, the tongue opening 578 has a shape corresponding to a shape of the tongue 126. In embodiments, a locking member spring recess 588 (FIG. 17) is formed in the tongue cavity 580 of the inner frame member 554. When provided, the locking member spring recess 588, as shown in FIG. 17, extends at least partially through the sling engagement portion 568 in a direction opposite the upper surface 564 of the inner frame member 554.

Referring again to FIGS. 18 and 19, in embodiments, a button spring recess 582 is formed in the front surface 570 of the body 558 of the inner frame member 554. A plurality of latch spring channels 584 extend through the front surface 570 and the rear surface 572 of the body 558 of the inner frame member 554. The latch spring channels 584 are formed on opposite sides of the button spring recess 582. A plurality of button arm channels 586 extend through the front surface 570 and the rear surface 572 of the body 558 of the inner frame member 554. The button arm channels 586 are formed on opposite sides of the button spring recess 582. Additionally, the button arm channels 586 are formed between the latch spring channels 584 and the lower surface 566 of the body 558 of the inner frame member 554.

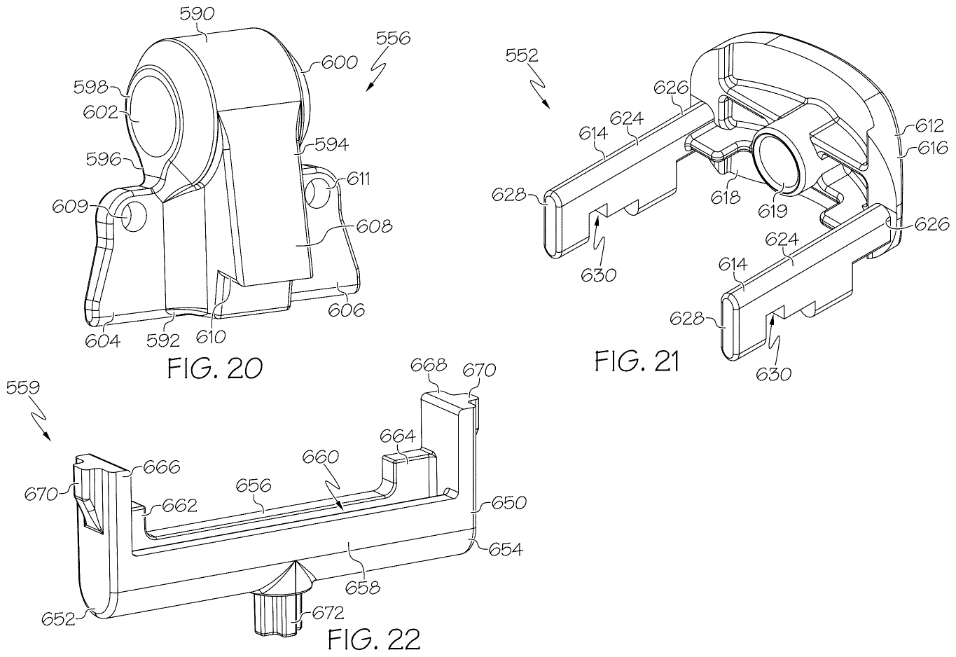

Referring now to FIG. 20, the latch 556 is shown apart from the other components of the buckle receiver 506. The latch 556 includes an upper end 590, a lower end 592 opposite the upper end 590, a front surface 594, a rear surface 596 opposite the front surface 594, a first side wall 598 extending between the front surface 594 and the rear surface 596, and a second side wall 600 opposite the first side wall 598 and extending between the front surface 594 and the rear surface 596.

In embodiments, a bore 602 is formed at the upper end 590 of the latch 556 extending through the first side wall 598 and the second side wall 600. In embodiments, the front surface 594 of the latch 556 includes a protrusion 608 extending in a direction away from the rear surface 596 of the latch 556. The protrusion 608 defines a lower wall 610. In embodiments, the lower wall 610 is planar. In other embodiments, a tooth or other friction inducing feature may be provided on the lower wall 610 and extending in a direction toward the lower end 592 of the latch 556. The latch 556 further includes a first flange 604 extending from the first side wall 598 in a direction opposite the second side wall 600, and a second flange 606 extending from the second side wall 600 in a direction opposite the first side wall 598. A first latch spring aperture 609 is formed in the first flange 604, and a second latch spring aperture 611 is formed in the second flange 606.

Referring now to FIG. 21, the button 552 is shown apart from the other components of the buckle receiver 506. The button 552 includes a contact portion 612 and one or more arms 614 extending from the contact portion 612. As shown, the button 552 includes a pair of arms 614. The contact portion 612 includes a front surface 616 and a rear surface 618 opposite the front surface 616. In embodiments, the front surface 616 has a convex shape. In embodiments, the rear surface 618 has a concave shape such that the contact portion 612 as a whole has a curved shape. In embodiments, a visual indicator is provided along a perimeter of the contact portion 612. For example, the visual indicator may be a color different than a color of the contact portion 612 itself, which is only visible through the button opening 150 when the button 552 is in an extended position. In embodiments, a button spring receiver 619 is formed in the rear surface 618 of the button 552.

The arms 614 of the button 552 each includes a body 624 having a front end 626 and a rear end 628 opposite the front end 626. The front end 626 of the body 624 of each arm 614 is fixed to the rear surface 618 of the contact portion 612. In embodiments, the arms 614 may be formed as a one-piece, monolithic structure with the contact portion 612. In other embodiments, the arms 614 may be separately formed and attached to the contact portion 612. A notch 630 is formed in the body 624 of each arm 614 between the front end 626 and the rear end 628.

Referring now to FIG. 22, the locking member 559 is shown apart from the other components of the buckle receiver 506. The locking member 559 includes a body 650 having a first end 652 and a second end 654 opposite the first end 652. The body 650 includes a first wall 656 and a second wall 658 each extending between the first end 652 and the second end 654. The first wall 656 and the second wall 658 are separated by a slot 660 extending into the body 650 between the first end 652 and the second end 654 of the body 650. In embodiments, the first wall 656 defines a first blocking portion 662 formed at the first end 652 of the body 650, and a second blocking portion 664 formed at the second end 654 of the body 650. In other embodiments, the first wall 656 includes only the first blocking portion 662 or the second blocking portion 664. The locking member 559 includes a first leg 666 extending in a first direction from the first end 652 of the body 650, and a second leg 668 extending from the second end 654 in the first direction parallel to the first leg 666. In embodiments, the first leg 666 and the second leg 668 each include a guide 670 formed on a respective surface of the first leg 666 and the second leg 668 facing a direction opposite the body 650. The locking member 559 includes a post 672 positioned at a generally central longitudinal position along the body 650 between the first end 652 and the second end 654 of the body 650. The post 672 extends in a second direction opposite the first direction in which the first leg 666 and the second leg 668 extend.

Referring again to FIG. 17, a cross-sectional side view of the buckle assembly 514 is shown in the inserted position and in a locked state. As shown, the housing 538 of the buckle receiver 506 is provided around the inner frame member 554 to enclose the other components of the buckle receiver 506, thereby protecting the components from damage and unintended external contact. With the housing 538 positioned around the inner frame member 554, the upper surface 564 of the inner frame member 554 is received within the frame opening 546 of the housing 538. The latch 556 is shown provided within the housing 538 and engaged with the inner frame member 554. Specifically, a pin 632 extends through the bore 602 of the latch 556 to rotatably couple the latch 556 to the inner frame member 554.

Additionally, as shown in FIG. 17, the housing 538 includes a guide wall 634 extending from the button opening 550. The guide wall 634 defines an outer button channel 636 to assist with guiding the contact portion 612 of the button 552 along the outer button channel 636 during depression of the button 552. As shown, a button biasing member 640 such as, for example, a spring, is positioned between the contact portion 612 of the button 552 and the inner frame member 554. Specifically, the button biasing member 640 is received within the button spring recess 582 formed in the inner frame member 554, and the button spring receiver 619 formed on the button 552 to retain the button biasing member 640 therebetween. Accordingly, upon the button 552 being depressed, the button 552 is biased by the button biasing member 640 back toward an extended position as shown in FIG. 17. As noted above, a visual indicator may be provided along the perimeter of the contact portion 612. Accordingly, with the button 552 in the extended position shown in FIG. 17, the visual indicator may be visible from outside of the housing 138.

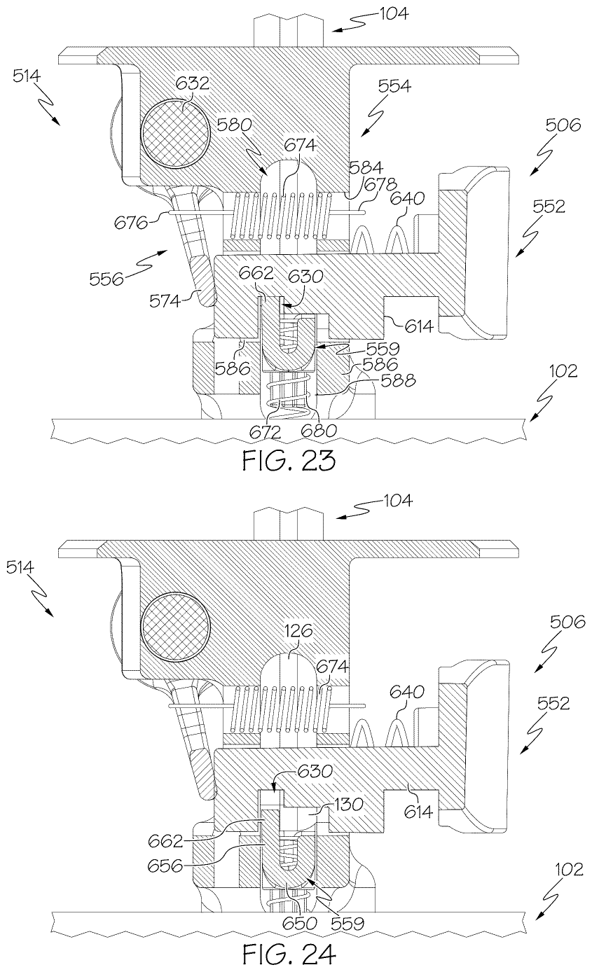

During insertion of the tongue 126 into the tongue cavity 580 of the inner frame member 554, the lower end 130 of the tongue 126 contacts the protrusion 608 of the latch 556 to rotate the latch 556 in a first rotation direction, such as a clockwise direction, about the pin 632. Once the lower end 130 of the tongue 126 is lower than the lower wall 610 of the protrusion 608, a latch biasing member 674, as shown in FIG. 23 and described in more detail herein, urges the latch 556 to rotate back in a second rotation direction opposite the first rotation direction, such as a counterclockwise direction, such that the protrusion 608 enters the slot 134 formed in the tongue 126. It should be appreciated that reference to clockwise or clockwise rotation of the latch 556 is merely with respect to the view shown in FIGS. 17 and 23-26. Accordingly, the direction of rotation would be opposite if viewed from the opposite side of the buckle assembly 514.

Referring now to FIG. 23, a cross-sectional side view of the buckle assembly 514, taken through one of the arms 614 of the button 552, is shown in the inserted position and in the locked state. The arm 614 of the button 552 is shown extending through a respective button arm channel 586 formed in the inner frame member 554. With the arm 614 of the button 552 extending through the inner frame member 554, the arm 614 contacts a respective lobe 574 of the latch 556.

As shown, the latch biasing member 674, such as a spring, extends through the latch spring channel 584 formed in the inner frame member 554. The latch biasing member 674 includes a first end 676 that engages the first latch spring aperture 609 (FIG. 20) formed in the first flange 604, and a widened second end 678 that inhibits removal of the latch basing member 674 from the latch spring channel 584. Although not shown, it should be appreciated that a second latch biasing member 674 may also extend through another latch spring channel 584 and engage the second latch spring aperture 611 (FIG. 20) formed in the second flange 606. Accordingly, any movement of the button 552 by pressing the contact portion 612 or permitting the button 552 to return to its initial position via the button biasing member 640 results in a corresponding rotating movement of the latch 556 about the pin 632 via the latch biasing member 674.

Additionally, as shown in FIG. 23, the first blocking portion 662 of the locking member 559 is shown received within the notch 630 formed in the arm 614. With the first blocking portion 662 received within the notch 630 of the arm 614, the button 552 is inhibited from being moved in a direction toward the latch 556. Although not shown, it should be appreciated that the second blocking portion 664 (FIG. 22) similarly engages the notch 230 formed in the other arm 614 of the button 552. The locking member 559 is shown positioned within the tongue cavity 580 formed in the inner frame member 554 and movable between a raised position and a lowered position relative to the inner frame member 554. As shown, the locking member 559 is in the raised position such that the first blocking portion 662 is received within the notch 230 of the arm 614. A locking biasing member 680, such as a spring, is positioned within the locking member spring recess 588 formed in the inner frame member 554 and circumscribes the post 672 of the locking member 559 to urge the locking member 559 into the raised position. Accordingly, with the locking member 559 in the raised position, the buckle assembly 514, while still in the inserted position, is in the locked state.

Referring now to FIG. 24, steps are taken to remove the buckle 104 from the buckle receiver 506 by initially lifting the buckle receiver 506 relative to the buckle 104. This may be done by lifting the sling bar 102 to which the buckle receiver 506 is attached. As the buckle receiver 506 is raised, the lower end of the 130 of the tongue 126 abuts against the body 650 of the locking member 559 to prevent the locking member 559 from moving relative to the rest of the buckle receiver 506. Accordingly, with the buckle receiver 506 lifted relative to the buckle 104, the buckle assembly 514, while still in the inserted position, is in a compressed state. Alternatively, the buckle 104 may be lowered or pushed toward the buckle receiver 506 to position the buckle assembly 514 into the compressed state. As shown in FIG. 24, when in the compressed state, the first blocking portion 662 of the first wall 656 of the locking member 559 is no longer received within the notch 630 formed in the arm 614 of the button 552.

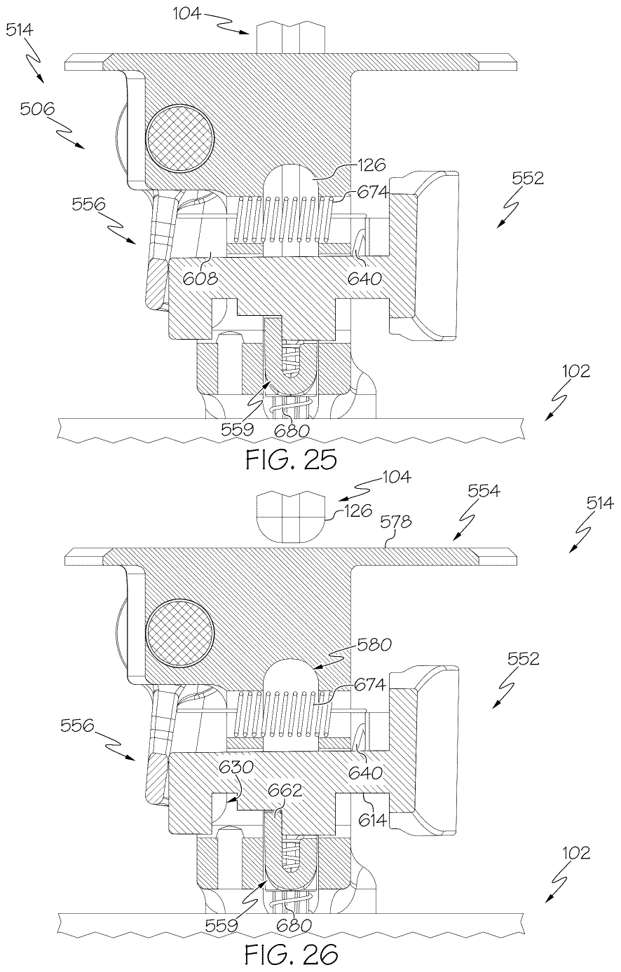

Thereafter, as shown in FIG. 25, the button 552 may be depressed to translate in a first direction and rotate the latch 556 in the clockwise direction. With the latch 556 rotated in the clockwise direction, the protrusion 608 is removed from the slot 134 (FIG. 17) formed in the tongue 126, thereby permitting the buckle 104 to be removed from the buckle receiver 506. With the latch 556 disengaged from the tongue 126, the buckle assembly 514, while still in the inserted position, is in an unlocked state. With the button 552 in the retracted or depressed position shown in FIG. 25, the visual indicator may not be visible from outside of the housing 138 (FIG. 17).

Referring now to FIG. 26, with the buckle assembly 514 in the unlocked state, the tongue 126 is permitted to be removed from the tongue cavity 580 formed in the inner frame member 554. This may be done by lowering the buckle receiver 506 relative to the buckle 104 or alternatively lifting the buckle 104 relative to the buckle receiver 506. In either instance, the tongue 126 slides out of the tongue opening 578 formed in the inner frame member 554. Once the tongue 126 is removed from the inner frame member 554 and the force applied against the button 552 is no longer applied, the button biasing member 640 urges the button 152 in a second direction opposite the first direction back to the extended position, and the latch biasing member 674 rotates the latch 556 in the counterclockwise direction. Thereafter, the locking biasing member 680 urges the locking member 559 back into the raised position such that the first blocking portion 662 of the locking member 559 engages the notch 630 formed in the arm 614 of the button 552 to inhibit further movement of the button 552, as shown in FIG. 23.

From the above, it is to be appreciated that defined herein is a buckle assembly for coupling a sling bar to a buckle. The buckle assembly includes a buckle receiver mounted to the sling bar and buckle received within the buckle receiver. The buckle receiver includes a button for operating a latch of the buckle receiver to selectively engage the buckle, thereby inhibiting removal of the buckle from the buckle receiver. Movement of the button in a first direction rotates the latch in a first rotation direction. The button is biased by the biasing member in a second direction opposite the first direction.

Further aspects of the embodiments described herein are provided by the subject matter of the following clauses:

A buckle receiver comprising: a housing defining a button opening; an inner frame member provided within the housing, the inner frame member defining a tongue opening and a tongue cavity; a latch rotatably coupled to the inner frame member, the latch including a protrusion and a button retainer, the protrusion positionable within the tongue cavity; and a button including a contact portion and shaft extending from the contact portion, the contact portion received within the button opening, the shaft received within the button retainer, wherein movement of the button in a first direction away from the button opening rotates the latch in a first rotation direction, wherein the button is biased in a second direction opposite the first direction toward the button opening.

The buckle receiver of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The buckle receiver of any preceding clause, wherein the housing comprises a guide wall extending from the button opening, the guide wall including a cutout.

The buckle receiver of any preceding clause, wherein the button includes a tab mounted to a rear surface of the contact portion of the button, the tab received within the cutout formed in the guide wall.

The buckle receiver of any preceding clause, wherein: the inner frame member includes a front surface and a recess wall recessed within the front surface, the recess wall defining a recess, an inner button channel extending from the recess wall to the tongue cavity; and the shaft of the button extends through the recess and the inner button channel.

The buckle receiver of any preceding clause, further comprising a biasing member provided between the contact portion of the button and the recess wall of the inner frame member.

The buckle receiver of any preceding clause, wherein the biasing member is a spring.

The buckle receiver of any preceding clause, wherein a latch slot is formed in the front surface of the inner frame member, the latch slot extends in a vertical direction between the tongue opening and the recess.

The buckle receiver of any preceding clause, wherein the button retainer comprises a pair of fingers spaced apart from one another.

The buckle receiver of any preceding clause, wherein a notch is formed in the shaft of the button to define a reduced diameter portion having a diameter less than a distance between each finger of the pair of fingers.

A buckle assembly comprising: a buckle comprising a tongue and a slot formed in the tongue; and a buckle receiver comprising: an inner frame member defining a tongue opening; a latch rotatably coupled to the inner frame member, the latch including a protrusion and a button retainer; and a button including a contact portion and shaft extending from the contact portion, the shaft received within the button retainer, wherein the tongue is positionable to extend through the tongue opening and into the inner frame member, wherein the protrusion is positionable into the slot of the tongue when the tongue is received within the inner frame member, wherein movement of the button in a first direction rotates the latch in a first rotation direction, wherein the button is biased in a second direction opposite the first direction.

The buckle assembly of any preceding clause, wherein the buckle comprises a strap receiving portion rotatably coupled to the tongue.

The buckle assembly of any preceding clause, wherein the tongue comprises a tapered edge extending into the slot.

The buckle assembly of any preceding clause, wherein: the buckle receiver comprises a housing defining a button opening; the inner frame member is provided within the housing; and the contact portion received within the button opening.

The buckle assembly of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The buckle assembly of any preceding clause, wherein the button retainer comprises a pair of fingers spaced apart from one another.

The buckle assembly of any preceding clause, wherein a notch is formed in the shaft of the button to define a reduced diameter portion having a diameter less than a distance between each finger of the pair of fingers.

A sling bar assembly comprising: a sling bar including a body and a pair of attachment hooks provided at opposite ends of the body; and a buckle receiver comprising: a housing defining a button opening; an inner frame member provided within the housing, the inner frame member defining a tongue opening and a tongue cavity, the inner frame member mounted to the body of the sling bar; a latch rotatably coupled to the inner frame member, the latch including a protrusion and a button retainer, the protrusion positionable within the tongue cavity; and a button including a contact portion and shaft extending from the contact portion, the contact portion received within the button opening, the shaft received within the button retainer, wherein movement of the button in a first direction away from the button opening rotates the latch in a first rotation direction, wherein the button is biased in a second direction opposite the first direction toward the button opening.

The sling bar assembly of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The sling bar assembly of any preceding clause, wherein: the button retainer comprises a pair of fingers spaced apart from one another; and a notch is formed in the shaft of the button to define a reduced diameter portion having a diameter less than a distance between each finger of the pair of fingers.

A person lifting system comprising: a lift member movable by a motor; a sling bar configured to be attached to a sling for holding a person; a buckle system for retaining the sling bar to the lift member, wherein the buckle system comprises: a buckle provided at an end of the lift member, the buckle comprising: a tongue; and a slot formed in the tongue; and a buckle receiver mounted on the sling bar, the buckle receiver comprising: an inner frame member defining a tongue opening; a latch rotatably coupled to the inner frame member, the latch including a protrusion and a button retainer; and a button including a contact portion and shaft extending from the contact portion, the shaft received within the button retainer, wherein the tongue is positionable to extend through the tongue opening and into the inner frame member, wherein the protrusion is positionable into the slot of the tongue when the tongue is received within the inner frame member, wherein movement of the button in a first direction rotates the latch in a first rotation direction, wherein the button is biased in a second direction opposite the first direction.

The person lifting system of any preceding clause, wherein the buckle comprises a strap receiving portion rotatably coupled to the tongue.

The person lifting system of any preceding clause, wherein the tongue comprises a tapered edge extending into the slot.

The person lifting system of any preceding clause, wherein: the buckle receiver comprises a housing defining a button opening; the inner frame member is provided within the housing; and the contact portion received within the button opening.

The person lifting system of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The person lifting system of any preceding clause, wherein the button retainer comprises a pair of fingers spaced apart from one another.

The person lifting system of any preceding clause, wherein a notch is formed in the shaft of the button to define a reduced diameter portion having a diameter less than a distance between each finger of the pair of fingers.

A buckle receiver comprising: a housing defining a button opening; an inner frame member provided within the housing, the inner frame member defining a tongue opening and a tongue cavity; a latch rotatably coupled to the inner frame member, the latch including a pivot bar and a protrusion positionable within the tongue cavity; and a button including a contact portion and an arm extending from the contact portion, the contact portion received within the button opening, the arm rotatably coupled to the pivot bar, wherein movement of the button in a first direction away from the button opening rotates the latch in a first rotation direction, wherein the button is biased in a second direction opposite the first direction toward the button opening.

The buckle receiver of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The buckle receiver of any preceding clause, wherein the housing comprises a guide wall extending from the button opening.

The buckle receiver of any preceding clause, wherein: the inner frame member includes a front surface and a recess wall recessed within the front surface.

The buckle receiver of any preceding clause, further comprising a biasing member provided between the contact portion of the button and the recess wall of the inner frame member.

The buckle receiver of any preceding clause, wherein the biasing member is a spring.

A buckle receiver comprising: a housing defining a button opening; an inner frame member provided within the housing, the inner frame member defining a tongue opening and a tongue cavity; a latch rotatably coupled to the inner frame member, the latch including a protrusion positionable within the tongue cavity; a locking member positionable within the tongue cavity of the inner frame member and biased into a raised position from a lowered position; and a button including a contact portion and an arm extending from the contact portion, the contact portion received within the button opening, the arm abutting against the latch, wherein movement of the button in a first direction away from the button opening rotates the latch in a first rotation direction, wherein the button is inhibited from moving in the first direction when the locking member is in the raised position, wherein the button is biased in a second direction opposite the first direction toward the button opening.

The buckle receiver of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The buckle receiver of any preceding clause, wherein the housing comprises a guide wall extending from the button opening.

The buckle receiver of any preceding clause, wherein: the inner frame member includes a front surface and a button spring recess recessed within the front surface; and the button includes a button spring receiver formed on the contact portion of the button.

The buckle receiver of any preceding clause, further comprising a button biasing member provided between the button spring recess of the inner frame member and the button spring receiver of the button.

The buckle receiver of any preceding clause, wherein the button biasing member is a spring.

The buckle receiver of any preceding clause, further comprising a locking biasing member biasing the locking member toward the raised position from the lowered position.

The buckle receiver of any preceding clause, wherein: a notch is formed in the arm of the button; and the locking member includes a blocking portion received within the notch when the locking member is in the raised position to inhibit movement of the button in the first direction.

The buckle receiver of any preceding clause, wherein: a button arm channel is formed in the inner frame member; and the arm of the button extends through the button arm channel to abut against the latch.

The buckle receiver of any preceding clause, wherein: a latch spring channel is formed in the inner frame member; and a latch biasing member extends through the latch spring channel to bias the latch in the second rotation direction.

The buckle receiver of any preceding clause, wherein the latch biasing member comprises: a first end engaging the latch; and a widened second end opposite the first end that inhibits removal of the latch basing member from the latch spring channel.

A person lifting system comprising: a lift member movable by a motor; a sling bar configured to be attached to a sling for holding a person; and a buckle system for retaining the sling bar to the lift member, wherein the buckle system comprises: a buckle provided at an end of the lift member, the buckle comprising: a tongue; and a slot formed in the tongue; and a buckle receiver mounted on the sling bar, the buckle receiver comprising: a housing defining a button opening; an inner frame member provided within the housing, the inner frame member defining a tongue opening and a tongue cavity; a latch rotatably coupled to the inner frame member, the latch including a protrusion positionable within the tongue cavity; a locking member positionable within the tongue cavity of the inner frame member and biased into a raised position from a lowered position; and a button including a contact portion and an arm extending from the contact portion, the contact portion received within the button opening, the arm abutting against the latch, wherein the tongue is positionable to extend through the tongue opening and into the inner frame member, wherein movement of the button in a first direction away from the button opening rotates the latch in a first rotation direction, wherein the button is inhibited from moving in the first direction when the locking member is in the raised position, wherein the button is biased in a second direction opposite the first direction toward the button opening.

The person lifting system of any preceding clause, wherein: the inner frame member includes a first side wall and a second side wall opposite the first side wall, the first side wall and the second side wall each includes a lobe and an aperture formed in the lobe; a bore is formed in an upper end of the latch; and a pin extends through the apertures of the first side wall and the second side wall of the inner frame member and the bore of the latch to rotatably couple the latch to the inner frame member.

The person lifting system of any preceding clause, wherein the housing comprises a guide wall extending from the button opening.

The person lifting system of any preceding clause, wherein: the inner frame member includes a front surface and a button spring recess recessed within the front surface; and the button includes a button spring receiver formed on the contact portion of the button.

The person lifting system of any preceding clause, further comprising a button biasing member provided between the button spring recess of the inner frame member and the button spring receiver of the button.

The person lifting system of any preceding clause, wherein the button biasing member is a spring.

The person lifting system of any preceding clause, further comprising a locking biasing member biasing the locking member toward the raised position from the lowered position.

The person lifting system of any preceding clause, wherein: a notch is formed in the arm of the button; and the locking member includes a blocking portion received within the notch when the locking member is in the raised position to inhibit movement of the button in the first direction.

The person lifting system of any preceding clause, wherein: a button arm channel is formed in the inner frame member; and the arm of the button extends through the button arm channel to abut against the latch.

The person lifting system of any preceding clause, wherein: a latch spring channel is formed in the inner frame member; and a latch biasing member extends through the latch spring channel to bias the latch in the second rotation direction.

The person lifting system of any preceding clause, wherein the latch biasing member comprises: a first end engaging the latch; and a widened second end opposite the first end that inhibits removal of the latch basing member from the latch spring channel.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A buckle receiver comprising:
a housing defining a button opening;
an inner frame member provided within the housing, the inner frame member defining a tongue opening and a tongue cavity;
a latch rotatably coupled to the inner frame member, the latch including a protrusion positionable within the tongue cavity;
a locking member positionable within the tongue cavity of the inner frame member and biased into a raised position from a lowered position; and
a button including a contact portion and an arm extending from the contact portion, the contact portion received within the button opening, the arm abutting against the latch,
wherein movement of the button in a first direction away from the button opening rotates the latch in a first rotation direction,
wherein the button is inhibited from moving in the first direction when the locking member is in the raised position,
wherein the button is biased in a second direction opposite the first direction toward the button opening.

2. The buckle receiver of claim 1, wherein:
the inner frame member includes a first side wall and a second side wall opposite the first side wall, the first side wall and the second side wall each includes a lobe and an aperture formed in the lobe;
a bore is formed in an upper end of the latch; and
a pin extends through the apertures of the first side wall and the second side wall of the inner frame member and the bore of the latch to rotatably couple the latch to the inner frame member.

3. The buckle receiver of claim 1, wherein the housing comprises a guide wall extending from the button opening.

4. The buckle receiver of claim 1, wherein:
the inner frame member includes a front surface and a button spring recess recessed within the front surface; and
the button includes a button spring receiver formed on the contact portion of the button.

5. The buckle receiver of claim 4, further comprising a button biasing member provided between the button spring recess of the inner frame member and the button spring receiver of the button.

6. The buckle receiver of claim 5, wherein the button biasing member is a spring.

7. The buckle receiver of claim 1, further comprising a locking biasing member biasing the locking member toward the raised position from the lowered position.

8. The buckle receiver of claim 1, wherein:
a notch is formed in the arm of the button; and
the locking member includes a blocking portion received within the notch when the locking member is in the raised position to inhibit movement of the button in the first direction.

9. The buckle receiver of claim 1, wherein:
a button arm channel is formed in the inner frame member; and
the arm of the button extends through the button arm channel to abut against the latch.

10. The buckle receiver of claim 1, wherein:
a latch spring channel is formed in the inner frame member; and
a latch biasing member extends through the latch spring channel to bias the latch in the second rotation direction.

11. The buckle receiver of claim 10, wherein the latch biasing member comprises:
a first end engaging the latch; and
a widened second end opposite the first end that inhibits removal of the latch basing member from the latch spring channel.

12. A person lifting system comprising:
a lift member movable by a motor;
a sling bar configured to be attached to a sling for holding a person; and
a buckle system for retaining the sling bar to the lift member, wherein the buckle system comprises:
a buckle provided at an end of the lift member, the buckle comprising:
a tongue; and
a slot formed in the tongue; and
a buckle receiver mounted on the sling bar, the buckle receiver comprising:
a housing defining a button opening;
an inner frame member provided within the housing, the inner frame member defining a tongue opening and a tongue cavity;
a latch rotatably coupled to the inner frame member, the latch including a protrusion positionable within the tongue cavity;
a locking member positionable within the tongue cavity of the inner frame member and biased into a raised position from a lowered position; and
a button including a contact portion and an arm extending from the contact portion, the contact portion received within the button opening, the arm abutting against the latch,
wherein the tongue is positionable to extend through the tongue opening and into the inner frame member,
wherein movement of the button in a first direction away from the button opening rotates the latch in a first rotation direction,
wherein the button is inhibited from moving in the first direction when the locking member is in the raised position,
wherein the button is biased in a second direction opposite the first direction toward the button opening.

13. The person lifting system of claim 12, wherein:
the inner frame member includes a first side wall and a second side wall opposite the first side wall, the first side wall and the second side wall each includes a lobe and an aperture formed in the lobe;
a bore is formed in an upper end of the latch; and
a pin extends through the apertures of the first side wall and the second side wall of the inner frame member and the bore of the latch to rotatably couple the latch to the inner frame member.

14. The person lifting system of claim 12, wherein the housing comprises a guide wall extending from the button opening.

15. The person lifting system of claim 12, wherein:
the inner frame member includes a front surface and a button spring recess recessed within the front surface; and
the button includes a button spring receiver formed on the contact portion of the button.

16. The person lifting system of claim 15, further comprising a button biasing member provided between the button spring recess of the inner frame member and the button spring receiver of the button.

17. The person lifting system of claim 16, wherein the button biasing member is a spring.

18. The person lifting system of claim 12, further comprising a locking biasing member biasing the locking member toward the raised position from the lowered position.

19. The person lifting system of claim 12, wherein:
a notch is formed in the arm of the button; and
the locking member includes a blocking portion received within the notch when the locking member is in the raised position to inhibit movement of the button in the first direction.

20. The person lifting system of claim 12, wherein:
a button arm channel is formed in the inner frame member; and
the arm of the button extends through the button arm channel to abut against the latch.
